(19) United States
(12) Patent Application Publication
(10) Pub. No.: US 2005/0123825 A1
(43) Pub. Date: Jun. 9, 2005

(54) Battery enclosure and remote control transmitter using the same

(75) Inventor: Takaya Nakamura, Fukui (JP)

Correspondence Address: McDERMOTT WILL & EMERY LLP, 600 13th Street, N.W., Washington, DC, 20005-3096, US

(73) Assignee: MATSUSHITA ELECTRIC INDUSTRIAL CO., LTD.

(21) Appl. No.: 10/959,979

(22) Filed: Oct. 8, 2004

(30) Foreign Application Priority Data
Dec. 9, 2003 (JP) 2003-410020

(51) Int. Cl. H01M 2/10

(52) U.S. Cl. 429/99; 429/100

(57) ABSTRACT

A battery enclosure has a containing section containing batteries in a linear array within the case. Fixed to the case and between the batteries, there is provided an intermediate electrode in contact with the batteries. By this configuration each of the batteries is individually held by the intermediate electrode. Hence battery is prevented from readily jumping out and held securely in place. Further, the elongated lid hardly comes off.

### TECHNICAL FIELD

The present invention chiefly relates to a battery enclosure for use in mobile electronic equipment such as a remote control transmitter and a digital camera.

### BACKGROUND ART

Recently, in mobile electronic equipment units such as remote control transmitters and digital cameras, there have been increasing in number such units as having a plurality of batteries contained in a battery enclosure within the equipment unit and having the unit electrically and mechanically driven by the batteries as the power source. Since the electronic equipment itself, in the case of the remote control transmitter in particular, is multi functional, there are provided a large number of buttons on the remote control transmitter. Since user operates the remote control transmitter with holding it in hand, those types formed in an elongated shape to allow such a large number of buttons to be disposed thereon are increasing in number.

Such a conventional battery enclosure is described below taking, as an example, a remote control transmitter incorporating the battery enclosure therein with reference to a sectional view of FIG. 3. Recessed on case 1 formed of an insulating resin into a box shape, there is provided containing section 2 in a cylindrical shape. There are contained batteries 3A, 3B arranged in a serial array within containing section 2, while an opening at the top of containing section 2 is covered with lid 4, and, thereby, battery enclosure 5 is configured.

On the left-hand end of containing section 2, there is mounted coil electrode 6 in a conical spiral shape. Battery 3A is urged by coil electrode 6 in its somewhat compressed state so as to be pressed against battery 3B, whereas battery 3B has its right-hand end placed in elastic contact with plane electrode 7 in a planar spiral shape.

There are provided a plurality of wiring patterns (not shown) on both sides of wiring board 8. On one side of wiring board 8, there are disposed fixed contacts (not shown) and there are also mounted electronic components such as light emitting diode 9A and microcomputer 9B and, thereby, controller 9 for emitting a remote control signal is configured. Batteries 3A, 3B supply controller 9 with electric power through coil electrode 6 and plane electrode 7.

Movable contact assembly 10 is made of rubber and has dome-shaped control buttons 10A. On the top face of each control button 10A, there is provided a movable contact (not shown) disposed opposite to a fixed contact on wiring board 8 with a predetermined distance therebetween. A switch contact is formed of the fixed contact and the movable contact. While resin-made cover 11 covers the bottom face of case 1, control buttons 1OA project from the bottom face of cover 11 movably up and down, thereby, a remote control transmitter is configured.

The remote control transmitter is pointed at an electric equipment unit and predetermined control buttons 10A for power supply and volume control, for example, are pressed down and released so that switch contacts are made and broken. Then, remote control signals of infrared rays corresponding to the operations are transmitted from controller 9 to the electronic equipment unit, thereby, remote control of turning ON/OFF and volume controlling of the electronic equipment unit is performed. A remote control transmitter of the described type is disclosed for example in Japanese Patent Unexamined Publication No. 2003-288870.

In such a conventional battery enclosure and a remote control transmitter using the same, one coil electrode 6 at the left-hand end of containing section 2 gives a press on battery 3A, which in turn gives a press on battery 3B, whereby battery 3B is resiliently pressed against plane electrode 7. Therefore, it is required that coil electrode 6 has a somewhat strong spring load. Because of this, however, it becomes difficult to stably hold the batteries and the batteries tend to jump out when they are exchanged. Also, when the remote control transmitter is dropped by accident, lid 4 comes off and the batteries are easily thrown out.

### SUMMARY OF THE INVENTION

A battery enclosure of the present invention has an intermediate electrode fixed to the case thereof and arranged in contact with a plurality of batteries contained therein in a linear array. Since the batteries are individually held by the intermediate electrode, the batteries are securely held in place and hardly jump out when exchanged. Although an elongated lid is used for covering the serially arrayed batteries, it hardly occurs that the lid comes off and the batteries are thrown out when the battery enclosure is dropped.

### BRIEF DESCRIPTION OF THE DRAWINGS

FIG. 1 is a sectional view of a remote control transmitter according to an embodiment of the present invention.

FIG. 2 is an exploded view in perspective of the remote control transmitter shown in FIG. 1.

FIG. 3 is a sectional view of a conventional remote control transmitter.

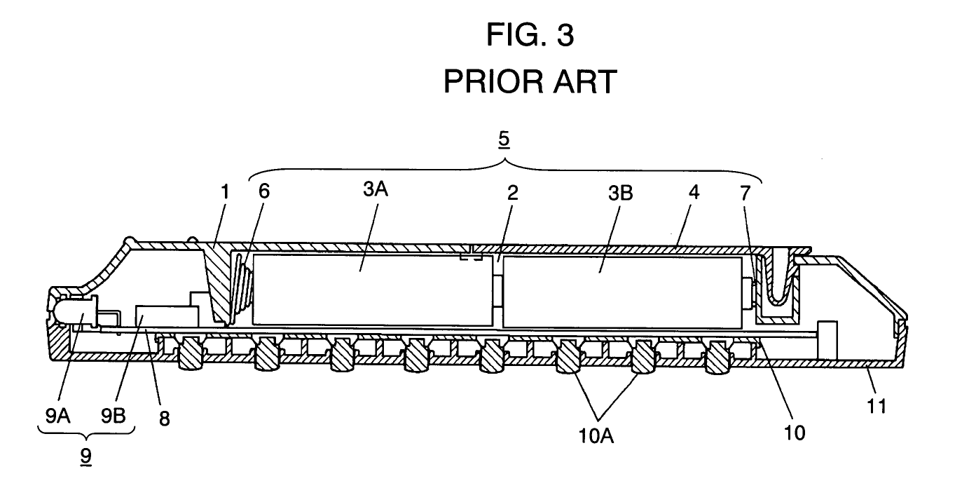

### DETAILED DESCRIPTION OF PREFERRED EMBODIMENT

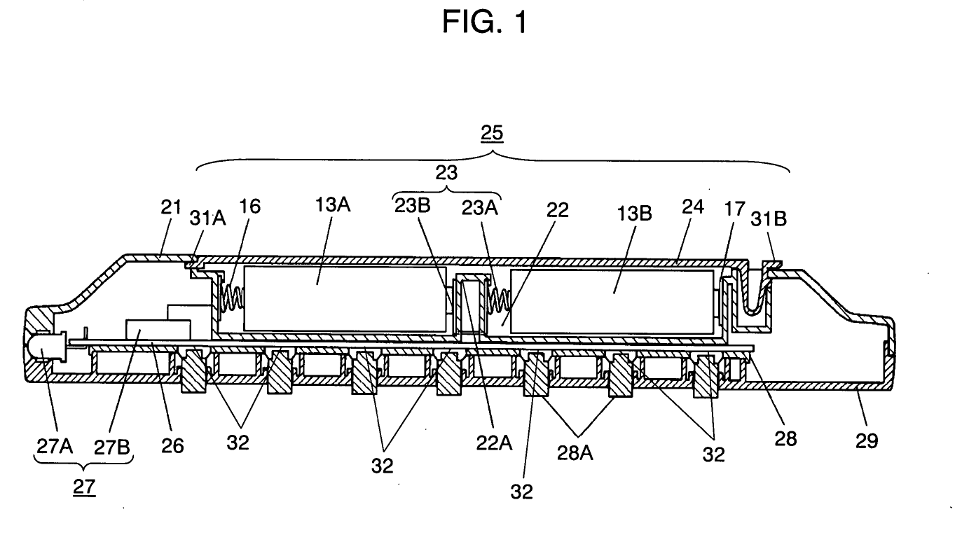

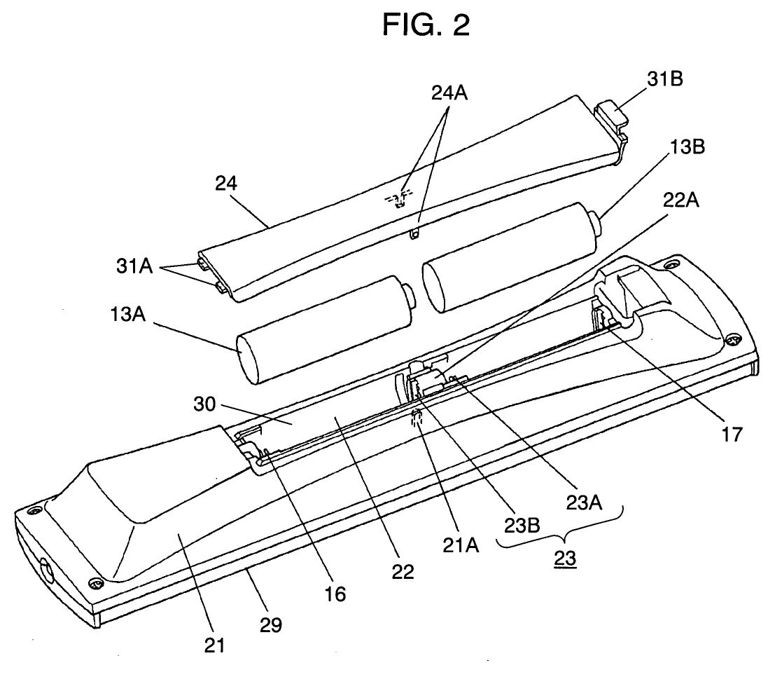

FIG. 1 is a sectional view of a remote control transmitter according to an embodiment of the present invention and FIG. 2 is an exploded view in perspective of the transmitter. Case 21 is made of such an insulating resin as polystyrene or acrylonitrile-butadiene-styrene formed into a box shape. Recessed on case 21, there is provided containing section 22 on one side thereof in a cylindrical shape. In the middle of containing section 22, there is provided projection 22A fixed to case 21. On projection 22A, there is mounted intermediate electrode 23 formed of coil portion (fourth electrode) 23A in a conical spiral shape and plane portion (third electrode) 23B in a planar spiral shape.

At the left-hand end of containing section 22, there is mounted coil electrode (first electrode) 16 made of a metallic wire in a conical spiral shape in its somewhat compressed state. Coil electrode 16 applies an urging force to the negative terminal of battery 13A so that the positive terminal of battery 13A is brought into elastic contact with planar portion 23B of intermediate electrode 23. Namely, planar portion 23B is adapted to make contact with the positive terminal of battery 13A. Coil portion 23A in its somewhat compressed state applies an urging force to the negative terminal of battery 13B so that the positive terminal of battery 13B is brought into elastic contact with plane electrode (second electrode) 17 in a planar spiral shape fixed to case 21 at the right-hand end of containing section 22. Namely, plane electrode 17 is adapted to make contact with the positive terminal of battery 13B. In this way, batteries 13A, 13B contained in containing section 22 in a serial array do not press each other directly. That is, coil electrode 16 and coil portion 23A individually apply their respective urging forces to batteries 13A, 13B, so that the batteries are brought into elastic contact with planar portion 23B and plane electrode 17, respectively. Intermediate electrode 23 is disposed between batteries 13A and 13B as described above.

At both sides of the substantially halfway portion of lid 24, which is made of an insulating resin into a flat shape, there are provided retaining claws (retaining portion) 24A projecting downward. Retaining claws 24A are adapted to be engaged with engagement portions 21A on case 21 so that lid 24 covers opening 30 provided at the top of containing section 22 and, thereby, battery enclosure 25 is configured. Opening 30 is provided along the total length of battery 13A and battery 13B. Battery 13A and battery 13B are arranged in a linear array corresponding to the elongated shape of the remote control transmitter. Lid 24 covering opening 30 has engagement portions 31A and 31B provided at both ends thereof near coil electrode 16 and plane electrode 17 and is adapted to open and close in its longitudinal direction.

Wiring board 26 made of paper-impregnated phenolic resin, glass-impregnated epoxy, or the like has wiring patterns (not shown) formed of copper on both sides thereof. On one side of wiring board 26, there are formed fixed contacts (not shown) and there are also mounted electronic components such as light emitting diode 27 and microcomputer 27B and, thereby, controller 27 for transmitting a remote control signal is configured. Batteries 13A, 13B connected by intermediate electrode 23 supply controller 27 with power through coil electrode 16 and plane electrode 17.

Movable contact assembly 28 made of silicone rubber, elastomer, or the like has dome-shaped control buttons 28A. On the top plane of the control button 28A, there is provided a movable contact (not shown) arranged to oppose a fixed contact on wiring substrate 26 with a predetermined distance therebetween. The fixed contact and movable contact constitute switch contact 32. Switch contacts 32 are connected to controller 27.

Cover 29 made of an insulating resin is fixedly attached to case 21 with screws or the like. While cover 29 covers the underside of case 21, control buttons 28A of movable contact assembly 28 project from the bottom face of cover 29 movably up and down, thereby, a remote control transmitter is configured.

The remote control transmitter is pointed at an electric equipment unit and predetermined control buttons 28A for power supply and volume control, for example, are pressed down and released so that switch contacts 32 are made and broken. Then, remote control signals of infrared rays corresponding to the operations are transmitted from controller 27 to the electronic equipment unit, thereby, turning power ON/OFF and adjusting the volume level of the electronic equipment unit are performed by remote controlling.

In battery enclosure 25 according to the present embodiment as described above, there is mounted intermediate electrode 23, in contact with battery 13A and battery 13B, at projection 22A in the middle of containing section 22 within case 21. By virtue of this configuration, battery 13A is urged by coil electrode 16 and battery 13B is urged by coil portion 23A and, therefore, it is not necessary that the spring loads of coil electrode 16 and coil portion 23A are extremely large. Further, since battery 13A and battery 13B are held individually, jumping out of the batteries or the like hardly occurs. Thus, a battery enclosure capable of securely holding batteries and a remote control transmitter using the same can be obtained. In this case, even if elongated lid 24 is used to cover batteries contained in a linear array, it hardly occurs that lid 24 comes off and the batteries are thrown out when battery enclosure 25 is dropped.

Further, retaining claws 24A provided around the center of lid 24 are engaged with engagement portions 21A provided on case 21. By virtue of this structure, lid 24 can be securely engaged with case 21 even when a certain degree of warp or deflection is produced in lid 24.

The present embodiment has been described above with a case where two batteries are housed in battery enclosure 25 taken as an example. Other than that, like advantage can be obtained even if three or more batteries are housed in the battery enclosure and projection 22A and intermediate electrode 23 are provided at, at least, one of the inter-battery spaces. It is desirable that the same arrangement be made at all of the inter-battery spaces. In that case, however, containing section 22 becomes longer according as the number of intermediate electrodes 23 is increased. Therefore, the number of intermediate electrodes 23 is required to be decided depending on the design of the remote control transmitter. Further, the number of set of retaining portion 24A and engagement portion 21A may be increased to two or more. In that case, it is preferred that the sets be equally spaced along the length of lid 24.

As described above, the battery enclosure and the remote control transmitter using the same according to the present invention are capable of securely holding batteries and useful when applied in particular to mobile electronic equipment.

1. A battery enclosure comprising:
A) a case having an opening portion capable of containing batteries arranged in a linear array and having a length extending from a first battery of the batteries at a first end to a second battery of the batteries at a second end opposite to the first end;
B) a first electrode fixed to the case for applying an urging force to a side of a first terminal of the first battery;
C) a second electrode fixed to the case adapted to make contact with a second terminal of the second battery having a polarity opposite to the first terminal;
D) an intermediate electrode fixed to the case and disposed between any of two batteries of the batteries, the intermediate electrode having:
D-1) a third electrode facing toward the first electrode; and
D-2) a fourth electrode facing toward the second electrode, rendered conductive with the third electrode, and applying an urging force to the battery making contact therewith; and
E) a lid for covering the opening portion and having first and second engagement portions on the side of the first end and on the side of the second end, respectively.

2. The battery enclosure according to claim 1, wherein the case has a containing section recessed on one side thereof in a cylindrical shape.

3. The battery enclosure according to claim 1, wherein the lid has retaining portions to be engaged with the case disposed between the first engagement portion and the second engagement portion.

4. A remote control transmitter comprising:
A battery enclosure including:
A) a case having an opening portion capable of containing batteries arranged in a linear array and having a length extending from a first battery of the batteries at a first end to a second battery of the batteries at a second end opposite to the first end;
B) a first electrode fixed to the case for applying an urging force to a side of a first terminal of the first battery;
C) a second electrode fixed to the case adapted to make contact with a second terminal of the second battery having a polarity opposite to the first terminal;
D) an intermediate electrode fixed to the case and disposed between any of two batteries of the batteries, the intermediate electrode having:
D-1) a third electrode facing toward the first electrode; and
D-2) a fourth electrode facing toward the second electrode, rendered conductive with the third electrode, and applying an urging force to the battery making contact therewith; and
E) a lid covering the opening portion and having first and second engagement portions on the side of the first end and on the side of the second end, respectively;
switch contacts; and
a controller connected with the switch contacts for transmitting a remote control signal in accordance with operation of the switch contacts.
